(19) United States
(12) Patent Application Publication
(10) Pub. No.: US 2024/0291043 A1
(43) Pub. Date: Aug. 29, 2024

(54) NONAQUEOUS ELECTROLYTE SECONDARY BATTERY

(71) Applicant: Prime Planet Energy & Solutions, Inc., Tokyo (JP)

(72) Inventor: Takuya ASARI, Kobe-shi (JP)

(21) Appl. No.: 18/439,767

(22) Filed: Feb. 13, 2024

(30) Foreign Application Priority Data
Feb. 28, 2023 (JP) 2023-029071

(51) Int. Cl. H01M 10/0587; H01M 10/0525; H01M 10/42

(52) U.S. Cl. CPC H01M 10/0587; H01M 10/42; H01M 10/0525; H01M 2010/4292

(57) ABSTRACT

In a nonaqueous electrolyte secondary battery disclosed herein, a length of a negative electrode active material layer in a winding axis direction of a wound electrode body is 200 mm or more, an infiltration speed of a nonaqueous electrolytic solution in the negative electrode active material layer is 0.02 μL/s to 0.05 μL/s, a distance between an end portion of a positive electrode active material layer and an end portion of the negative electrode active material layer is more than 0 mm and 5 mm or less in the winding axis direction, and, in a fully charged state, a ratio of the nonaqueous electrolytic solution to a total void volume of the positive electrode active layer and the negative electrode active layer in the wound electrode body is 130% or less.

### CROSS REFERENCE OF RELATED APPLICATION

This application claims the benefit of priority to Japanese Patent Application No. 2023-029071 filed on Feb. 28, 2023. The entire contents of this application are hereby incorporated herein by reference.

### BACKGROUND OF THE DISCLOSURE

### 1. Field

The present disclosure relates to a nonaqueous electrolyte secondary battery.

### 2. Background

For example, Japanese Patent Application Publication No. 2022-074818 discloses a large-size nonaqueous electrolyte secondary battery including a wound electrode body having a larger length in a winding axis direction (a width direction) than that of a wound electrode body of a known nonaqueous electrolyte secondary battery.

### SUMMARY

In particular, in the nonaqueous electrolyte secondary battery described above, a moving path of a nonaqueous electrolytic solution in the winding axis direction is long. Therefore, according to a study of the present inventor, there is still room for improvement from a viewpoint of suppressing high-rate deterioration.

In view of the foregoing, the present disclosure has been devised and it is therefore a major object of the present disclosure to provide a nonaqueous electrolyte secondary battery in which high-rate deterioration is preferably suppressed.

In order to achieve the above-described object, the present disclosure provides a nonaqueous electrolyte secondary battery that includes a wound electrode body configured such that a strip-shaped positive electrode and a strip-shaped negative electrode are wound with a strip-shaped separator interposed therebetween, a nonaqueous electrolytic solution, and a battery case that accommodates the wound electrode body and the nonaqueous electrolytic solution, and in which the positive electrode includes a positive electrode active material layer, the negative electrode includes a negative electrode active material layer, a length of the negative electrode active material layer in a winding axis direction of the wound electrode body is 200 mm or more, an infiltration speed of the nonaqueous electrolytic solution in the negative electrode active material layer is 0.02 μL/s or more and 0.05 μL/s or less, a distance between an end portion of the positive electrode active material layer and an end portion of the negative electrode active material layer is more than 0 mm and 5 mm or less on at least one side in the winding axis direction, and, in a fully charged state, a ratio of a volume of the nonaqueous electrolytic solution to a total void volume of the positive electrode active layer and the negative electrode active layer in the wound electrode body is 130% or less. Although details will be described later, according to the nonaqueous electrolyte secondary battery having the above-described configuration, high-rate deterioration can be preferably suppressed.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view schematically illustrating a nonaqueous electrolyte secondary batter according to one preferred embodiment.

FIG. 2 is a schematic longitudinal sectional view taken along line II-II of FIG. 1.

FIG. 3 is a schematic longitudinal sectional view taken along line III-III of FIG. 1.

FIG. 4 is a schematic cross-sectional view taken along line IV-IV of FIG. 1.

FIG. 5 is a perspective view schematically illustrating a wound electrode body mounted on a sealing plate.

FIG. 6 is a perspective view schematically illustrating a wound electrode body on which a positive electrode second current collector and a negative electrode second current collector are mounted.

FIG. 7 is a perspective view illustrating a configuration of the wound electrode body according to one preferred embodiment.

FIG. 8 is a schematic cross-sectional view taken along line VIII-VIII in FIG. 2.

FIG. 9 is a view illustrating a relationship between a liquid level height of the nonaqueous electrolytic solution and a height of the wound electrode body.

### DETAILED DESCRIPTION OF THE PREFERRED EMBODIMENTS

Preferred embodiments of a technology disclosed herein will be described below with reference to the accompanying drawings. In the drawings described below, the members and parts with the same operation are denoted by the same reference signs. A dimensional relation (of length, width, thickness, or the like) in each of the drawings does not necessarily reflect an actual dimensional relation. Note that matters other than matters specifically mentioned in this specification and necessary for carrying out the technology discussed herein (for example, general configuration and manufacturing process of a battery that do not characterize the present disclosure) can be understood as design matters for those skilled in the art based on the related art in the related field. The technology disclosed herein can be carried out based on contents disclosed in this specification and the common general technical knowledge in the field. Note that, in this specification, the notation “A to B” that indicates a range means “A or more and B or less.” The notation also includes “a range that exceeds A” and “a range less than B.”

Note that, as used in the present technology, the term “secondary battery” refers to a power storage device in general that can be repeatedly charged and discharged, and includes any so-called storage battery, such as a lithium-ion secondary battery, a lithium polymer battery, or the like, any storage element, such as an electric double layer capacitor or the like. The term “nonaqueous electrolyte secondary battery” refers to a secondary battery that realizes charging and discharging using a nonaqueous electrolyte as a charge carrier, and the electrolyte may be one of a gel electrolyte and a nonaqueous electrolyte. In a configuration that can enjoy benefits of the present technology, for example, a nonaqueous electrolytic solution that is in a liquid state at normal temperature (for example, 25° C.) and is obtained by dissolving a supporting salt (an electrolytic salt) that serves as a charge carrier in a nonaqueous solvent may be employed. Examples of the nonaqueous electrolyte secondary battery include a lithium-ion secondary battery, a sodium-ion secondary battery, or the like. The term “active material” refers to a material that can reversibly store and release a chemical species that serves as a charge carrier in a secondary battery. Moreover, as used in the present technology, the term “SOC” means a charging depth (state of charge) and indicates a charging state in a range of an operating voltage that can reversibly charge and discharge when it is assumed that a charging state where a voltage that is an upper limit of the range can be achieved is 100% and a charging state where a voltage that is a lower limit of thereof can be achieved is 0%. The present technology will be described below using, as an example, a case where a nonaqueous electrolyte secondary battery (or a nonaqueous electrolytic solution secondary battery) is a lithium-ion secondary battery.

### <Configuration of Battery>

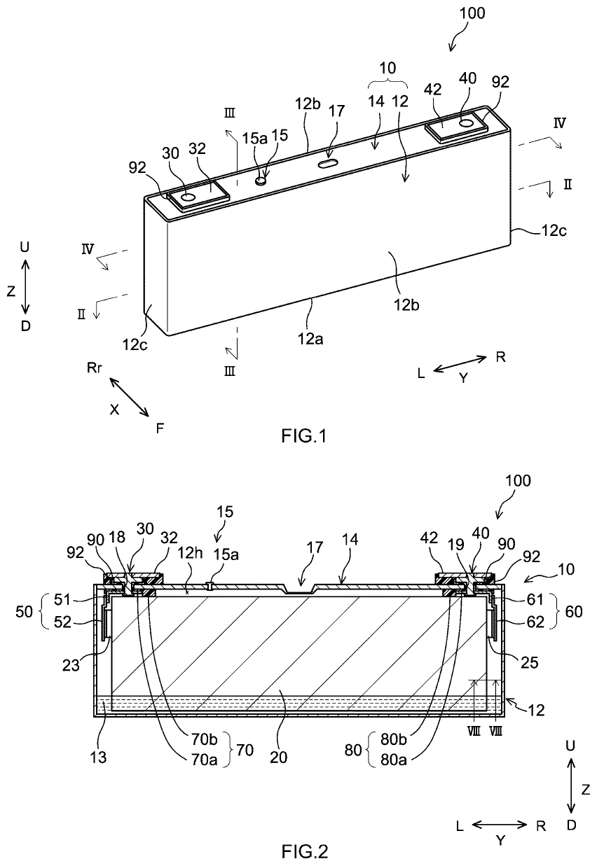

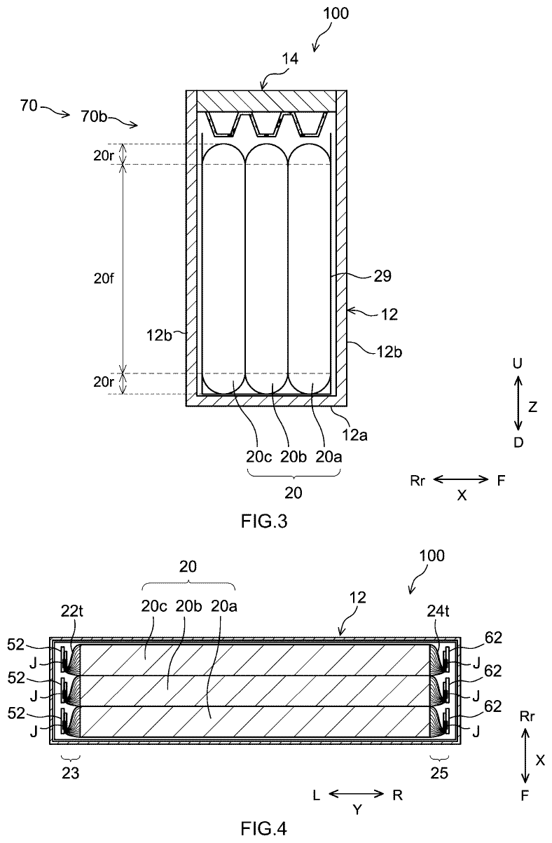

FIG. 1 is a perspective view of a nonaqueous electrolyte secondary battery (which will be hereinafter referred to simply as a “battery 100”) according to this preferred embodiment. FIG. 2 is a schematic longitudinal sectional view taken along line II-II of FIG. 1. FIG. 3 is a schematic longitudinal sectional view taken along line III-III of FIG. 1. FIG. 4 is a schematic cross-sectional view taken along line IV-IV of FIG. 1. In the following description, reference signs L, R, F, Rr, U, and D in the drawings denote left, right, front, rear, up, and down, respectively, and reference signs X, Y, and Z in the drawings denote a short side direction of the battery 100, a long side direction thereof orthogonal to the short side direction, and an up-down direction thereof orthogonal to the short side direction, respectively. However, these directions are defined for convenience of explanation, and do not limit an installation form of the battery 100.

As illustrated in FIG. 2, the battery 100 includes a case (battery case) 10 and an electrode body group 20. The battery 100 according to this preferred embodiment includes, in addition to the case 10 and the electrode body group 20, a positive electrode terminal 30, a positive electrode external conductive member 32, a negative electrode terminal 40, a negative electrode external conductive member 42, an external insulating member 92, a positive electrode current collector 50, a negative electrode current collector 60, a positive electrode internal insulating member 70, and a negative electrode internal insulating member 80. A sealing plate 14 includes the positive electrode terminal 30 and the negative electrode terminal 40. Although not illustrated, the battery 100 according to this preferred embodiment further includes an electrolytic solution 13. The battery 100 is herein a lithium-ion secondary battery. The battery 100 is a rectangular secondary battery.

The case 10 is a housing that accommodates the electrode body group 20. The case 10 has a flat and bottomed rectangular parallelopiped (rectangle) outer shape. The case 10 has a hexahedral rectangular parallelopiped outer shape. The case 10 may have a flat shape as in this preferred embodiment, and may not have a flat shape (for example, may have a cube shape or the like). A conventionally used material may be used for the case 10, and there is no particular limitation thereon. The case 10 is preferably formed of a metal having a predetermined strength. Examples of a metal material forming the case 10 include aluminum, aluminum alloy, iron, iron alloy, or the like.

The case 10 includes a case body 12, a sealing plate 14, and a gas exhaust valve 17. The case body 12 is a flat rectangular container having one side formed as an opening 12h. Specifically, as illustrated in FIG. 1, the case body 12 includes the opening 12h, an approximately rectangular bottom wall 12a, a pair of second side walls 12c extending upward U from short sides of the bottom wall 12a and opposed to each other, and a pair of first side walls 12b extending upward U from long sides of the bottom wall 12a and opposed to each other. An area of the first side wall 12b is larger than an area of the second side wall 12c. The opening 12h is formed at an upper surface of the case body 12 surrounded by the pair of first side walls 12b and the pair of second side walls 12c. The sealing plate 14 is mounted on the case body 12 so as to close the opening 12h of the case body 12. The sealing plate 14 is an approximately rectangular plate material when viewed from top. The sealing plate 14 is opposed to the bottom wall 12a of the case body 12. The case 10 is formed by joining (for example, welding joining) the sealing plate 14 to a peripheral edge of the opening 12h of the case body 12. Joining of the sealing plate 14 can be performed by welding, such as, for example, laser welding or the like. Specifically, each of the pair of second side walls 12c is joined to a corresponding short side of the sealing plate 14, and each of the first side walls 12b is joined to a corresponding long side of the sealing plate 14.

As illustrated in FIG. 1 and FIG. 2, the gas exhaust valve 17 is formed in the sealing plate 14. The gas exhaust valve 17 is configured to open and discharge gas in the case 10 when a pressure in the case 10 is a predetermined value or more. The gas exhaust valve 17 in this preferred embodiment is a recessed portion that has an approximately circular shape when viewed from top and is recessed from an outer surface of the sealing plate 14 toward the electrode body group 20. A thin portion having a smeller thickness than a thickness of the sealing plate 14 is formed on a bottom surface of the gas exhaust valve 17. The gas exhaust valve 17 is configured such that the thin portion is broken when a case internal pressure is the predetermined value or more. Thus, the gas in the case 10 is discharged to outside, so that the increased case internal pressure can be reduced.

In addition to the gas exhaust valve 17, a liquid injection hole 15 and two terminal insertion holes 18 and 19 are provided in the sealing plate 14. The liquid injection hole 15 is an opening that communicates with an internal space of the case body 12 and is provided for injecting a nonaqueous electrolytic solution in a manufacturing process of the battery 100. The liquid injection hole 15 is sealed by a sealing member 15a. As the sealing member 15a, for example, a blind rivet is preferably used. Thus, the sealing member 15a can be firmly fixed inside the case 10. Each of the terminal insertion holes 18 and 19 is formed in a corresponding one of both end portions of the sealing plate 14 in a long side direction Y. Each of the terminal insertion holes 18 and 19 passes through the sealing plate 14 in an up-down direction Z. As illustrated in FIG. 2, the positive electrode terminal 30 is inserted in the terminal insertion hole 18 at one side (a left side) in the long side direction Y. The negative electrode terminal 40 is inserted in the terminal insertion hole 19 at the other side (a right side) in the long side direction Y.

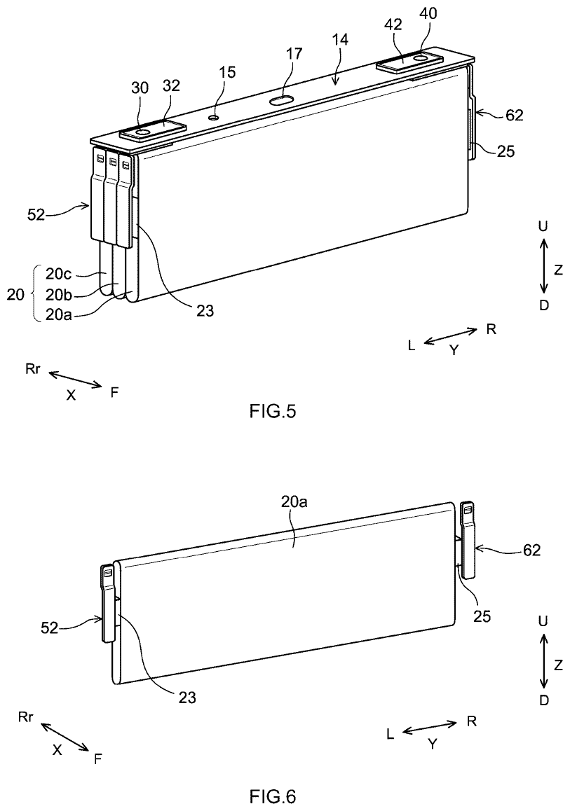

FIG. 5 is a perspective view schematically illustrating the electrode body group 20 mounted on the sealing plate 14. FIG. 6 is a perspective view schematically illustrating a wound electrode body 20a on which a positive electrode second current collector 52 and a negative electrode second current collector 62 are mounted. In this preferred embodiment, a plurality of (in this case, three) wound electrode bodies 20a, 20b, and 20c are accommodated in the case 10. Note that there is no particular limitation on a number of electrode bodies accommodated in one case 10, and the number of the electrode bodies may be one and may be two or more (plural). Note that, as illustrated in FIG. 5, in this preferred embodiment, the positive electrode current collector 50 is arranged on one side of each electrode body in the long side direction Y (a left side in FIG. 5) and the negative electrode current collector 60 is arranged on the other side thereof in the long side direction Y (a right side in FIG. 5). The wound electrode bodies 20a, 20b, and 20c are connected in parallel. However, the wound electrode bodies 20a, 20b, and 20c may be connected in series. The electrode body group 20 is herein accommodated in the case body 12 of the case 10 in a state of being covered by an electrode body holder 29 (see FIG. 3) formed of a resin sheet.

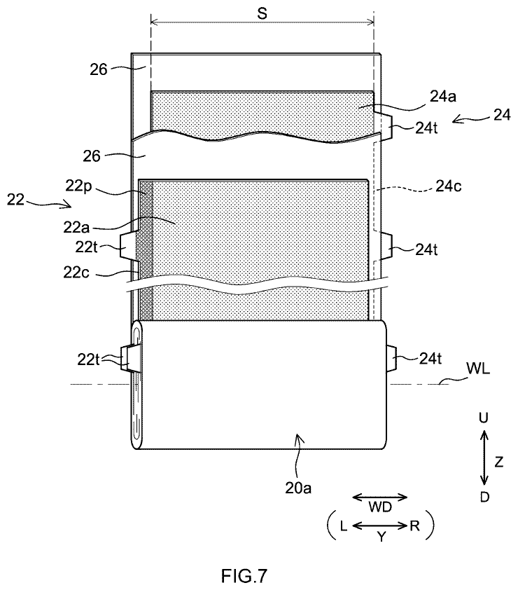

FIG. 7 is a perspective view schematically illustrating the wound electrode body 20a. Note that, although the wound electrode body 20a will be described in detail below as an example, each of the electrode body 20b and the electrode body 20c can be formed in a similar configuration.

As illustrated in FIG. 7, the wound electrode body 20a includes a positive electrode 22, a negative electrode 24, and a separator 26. The wound electrode body 20a is a wound electrode body configured such that the strip-shaped positive electrode 22 and the strip-shaped negative electrode 24 are stacked with two separators 26 interposed therebetween and an obtained stacked body is wound around a winding axis WL as a center. The wound electrode body 20a (20b, 20c) is preferably arranged such that the winding axis WL extends in a direction parallel to the bottom wall 12a of the case 10.

The wound electrode body 20a has a flat shape. In other preferred embodiment, a wound electrode body having a cylindrical shape or the like may be employed, but as in this preferred embodiment, a wound electrode body having a flat shape is preferable. The wound electrode body 20a is arranged in the case body 12 such that the winding axis WL extends approximately in parallel to the long side direction Y. A winding axis direction WD in which the winding axis WL extends is a direction that matches the long side direction Y. Specifically, as illustrated in FIG. 3, the wound electrode body 20a includes a pair of curved portions (R portions) 20r opposed to the bottom wall 12a of the case body 12 and the sealing plate 14 and a flat portion 20f that connects the pair of curved portions 20r and is opposed to the first side walls 12b of the case body 12. The flat portion 20f extends along the first side walls 12b.

As illustrated in FIG. 7, the positive electrode 22 includes a positive electrode current collector 22c, a positive electrode active material layer 22a and a positive electrode protective layer 22p that are fixed to at least one surface of the positive electrode current collector 22c. However, the positive electrode protective layer 22p is not essential and can be omitted in other preferred embodiments. The positive electrode current collector 22c has a strip shape. The positive electrode current collector 22c is formed of a conductive metal, such as, for example, aluminum, aluminum alloy, nickel, stainless steel, or the like. The positive electrode current collector 22c is a metal foil, specifically, an aluminum foil, herein.

A plurality of positive electrode tabs 22t are provided in one end portion of the positive electrode current collector 22c in the winding axis direction WD (a left end portion in FIG. 7). Each of the plurality of positive electrode tabs 22t has a raised shape (a tab shape) and the plurality of positive electrode tabs 22t are provided at intervals (intermittently) in a longitudinal direction of the strip-shaped positive electrode 22. Each of the plurality of positive electrode tabs 22t protrudes outward from the separator 26 toward one side (a left side in FIG. 7) in the winding axis direction WD. Note that the positive electrode tabs 22t may be provided in the other side in the winding axis direction WD (a right side when indicated in FIG. 7), and may be provided at each of both sides in the winding axis direction WD. The positive electrode tab 22t is a portion of the positive electrode current collector 22c and is formed of a metal foil (an aluminum foil). However, the positive electrode tab 22t may be a separate member from the positive electrode current collector 22c. The positive electrode active material layer 22a and the positive electrode protective layer 22p are not formed in at least a portion of the positive electrode tab 22t, and a region where the positive electrode current collector 22c is exposed is formed in the portion.

As illustrated in FIG. 4, at least some of the plurality of positive electrode tabs 22t overlap with each other in the one end portion in the winding axis direction WD (a left end portion in FIG. 4) to form a positive electrode tab group 23. Each of the plurality of positive electrode tabs 22t is bent such that respective outer side ends thereof are aligned. Thus, an accommodation property into the case 10 can be increased, and a size of the battery 100 can be reduced. As illustrated in FIG. 2, the positive electrode tab group 23 is electrically connected to the positive electrode terminal 30 via the positive electrode current collector 50. Specifically, the positive electrode tab group 23 and the positive electrode second current collector 52 are connected at a connection portion J (see FIG. 4). The positive electrode second current collector 52 is electrically connected to the positive electrode terminal 30 via a positive electrode first current collector 51. Note that respective sizes of the plurality of positive electrode tabs 22t (a length in the long side direction and a width in the winding axis direction WD that is orthogonal to the long side direction, see FIG. 7) can be adjusted as appropriate, for example, in accordance with a forming position or the like, considering a state of being connected to the positive electrode current collector 50. Herein, the respective sizes of the plurality of positive electrode tabs 22t are different from each other such that the respective outer side ends thereof are aligned when being bent.

As illustrated in FIG. 7, the positive electrode active material layer 22a is provided in a strip shape to extend in the longitudinal direction of the strip-shaped positive electrode current collector 22c. The positive electrode active material layer 22a includes a positive electrode active material (for example, lithium-transition metal compound oxide, such as lithium nickel cobalt manganese composite oxide or the like) that can reversibly store and release a charge carrier. When it is assumed that an entire solid content of the positive electrode active material layer 22a is 100 mass %, the positive electrode active material may occupy generally 80 mass % or more, typically 90 mass % or more, and, for example, 95 mass % or more. The positive electrode active material layer 22a may include an optional component, such as, for example, a conductive material, a binder, various additive components, or the like, in addition to the positive electrode active material. As the conductive material, a carbon material, such as, for example, acetylene black (AB) or the like, can be used. As the binder, for example, polyvinylidene fluoride (PVdF) or the like can be used.

As illustrated in FIG. 7, the positive electrode protective layer 22p is provided in a boundary portion between the positive electrode current collector 22c and the positive electrode active material layer 22a in the winding axis direction WD. Herein, the positive electrode protective layer 22p is provided in one end portion of the positive electrode current collector 22c in the winding axis direction WD (the left end portion in FIG. 7). However, the positive electrode protective layer 22p may be provided in both end portions of the positive electrode current collector 22c in the winding axis direction WD. The positive electrode protective layer 22p is provided in a strip shape to extend along the positive electrode active material layer 22a. The positive electrode protective layer 22p includes an inorganic filler (for example, alumina). When it is assumed that an entire solid content of the positive electrode protective layer 22p is 100 mass %, the inorganic filler may occupy generally 50 mass % or more, typically 70 mass % or more, and, for example, 80 mass % or more. The positive electrode protective layer 22p may include an optional component, such as, for example, a conductive material, a binder, various additive components, or the like, in addition to the inorganic filler. The conductive material and the binder may be the same as those described above as examples that can be included in the positive electrode active material layer 22a.

As illustrated in FIG. 7, the negative electrode 24 includes a negative electrode current collector 24c and a negative electrode active material layer 24a fixed to at least one surface of the negative electrode current collector 24c. The negative electrode current collector 24c has a strip shape. The negative electrode current collector 24c is formed of a conductive metal, such as, for example, copper, copper alloy, nickel, stainless steel, or the like. The negative electrode current collector 24c is a metal foil, specifically, a copper foil herein.

A plurality of negative electrode tabs 24t are provided in one end portion of the negative electrode current collector 24c in the winding axis direction WD (a right end portion in FIG. 7). Each of the plurality of negative electrode tabs 24t has a raised shape (a tab shape) and the plurality of negative electrode tabs 24t are provided at intervals (intermittently) in a longitudinal direction of the strip-shaped negative electrode 24. Each of the plurality of negative electrode tabs 24t protrudes outward from the separator 26 toward one side in the winding axis direction WD (a right side in FIG. 7). However, the negative electrode tabs 24t may be provided at the other end portion in the winding axis direction WD (the left end portion in FIG. 7), and may be provided at each of both sides in the winding axis direction WD. The negative electrode tab 24t is a portion of the negative electrode current collector 24c and is formed of a metal foil (a copper foil). However, the negative electrode tab 24t may be a separate member from the negative electrode current collector 24c. The negative electrode active material layer 24a is not formed at least in a portion of the negative electrode tab 24t, and a region where the negative electrode current collector 24c is exposed is provided in the portion.

As illustrated in FIG. 4, at least some of the plurality of negative electrode tabs 24t overlap each other in the one end portion in the winding axis direction WD (a right end portion in FIG. 4) to form a negative electrode tab group 25. The negative electrode tab group 25 is preferably provided in a position symmetrical to the positive electrode tab group 23 in the winding axis direction WD. Each of the plurality of negative electrode tabs 24t is bent such that respective outer side ends thereof are aligned. Thus, the accommodation property into the case 10 can be increased, and the size of the battery 100 can be reduced. As illustrated in FIG. 2, the negative electrode tab group 25 is electrically connected to the negative electrode terminal 40 via the negative electrode current collector 60. Specifically, the negative electrode tab group 25 and the negative electrode second current collector 62 are connected at a connection portion J (see FIG. 4). The negative electrode second current collector 62 is electrically connected to the negative electrode terminal 40 via a negative electrode first current collector 61. Similar to the plurality of positive electrode tabs 22t, herein, respective sizes of the plurality of negative electrode tabs 24t are different from each other such that the respective outer side ends thereof are aligned when being bent.

As illustrated in FIG. 7, the negative electrode active material layer 24a is provided in a strip shape to extend in the longitudinal direction of the strip-shaped negative electrode current collector 24c. A length of the negative electrode active material layer 24a is larger than a length of the positive electrode active material layer 22a in the winding axis direction WD that is orthogonal to the longitudinal direction. The negative electrode active material layer 24a protrudes outward from the positive electrode active material layer 22a in both sides in the winding axis direction WD (at left and right in FIG. 7). The negative electrode active material layer 24a includes a negative electrode active material (for example, a carbon material and a silicon-based material) that can reversibly store and release a charge carrier. Herein, examples of the carbon material include graphite, hard carbon, soft carbon, amorphous carbon, a combination thereof, or the like. Examples of the silicon-based material include silicon, silicon oxide (silica), a combination thereof, or the like. The silicon-based material may include, for example, some other metallic material (for example, alkaline earth metal), an oxide thereof, or the like. When it is assumed that an entire solid content of the negative electrode active material layer 24a is 100 mass %, the negative electrode active material may occupy generally 80 mass % or more, typically 90 mass % or more, and, for example, 95 mass % or more. The negative electrode active material layer 24a may include an optional component, such as, for example, a binder, a dispersant, various additive components, or the like, in addition to the negative electrode active material. As the binder, rubbers, such as, for example, styrene butadiene rubber (SBR) or the like, can be used. As the dispersant, celluloses, such as, for example, carboxymethyl cellulose (CMC) or the like, can be used. An electrode density of the negative electrode active material layer 24a is for example, 0.8 g/cm³ or more and an infiltration speed of the nonaqueous electrolytic solution is low. From a viewpoint of being preferable as an object to which the technology disclosed herein is applied, the electrode density is preferably 1.0 g/cm³ or more, and more preferably 1.3 g/cm³ or more. An upper limit of the electrode density of the negative electrode active material layer 24a is, for example, 3.0 g/cm³ or less, and may be 2.0 g/cm³ or less.

As illustrated in FIG. 7, the separator 26 is a member that insulates the positive electrode active material layer 22a of the positive electrode 22 and the negative electrode active material layer 24a of the negative electrode 24 from each other. As the separator 26, a porous resin sheet formed of polyolefin resin, such as, for example, polyethylene (PE), polypropylene (PP), or the like, is preferable. The separator 26 may include a base portion formed of a porous resin sheet and a heat resistance layer (HRL) provided at least on one surface of the base portion and including an inorganic filler. As the inorganic filler, for example, alumina, boehmite, aluminum hydroxide, titania, or the like can be used.

A nonaqueous electrolyte (nonaqueous electrolytic solution) similar to a known nonaqueous electrolyte may be employed. There is no particular limitation thereon. The nonaqueous electrolyte typically includes a nonaqueous solvent and a supporting salt (an electrolyte salt). As the nonaqueous solvent, various types of organic solvents, such as carbonates, ethers, esters, nitriles, sulfones, lactones, or the like, that are used for electrolytic solutions of general lithium-ion secondary batteries can be used without any particular limitation. Specific examples include ethylene carbonate (EC), propylene carbonate (PC), diethyl carbonate (DEC), dimethyl carbonate (DMC), ethyl methyl carbonate (EMC), monofluoroethylene carbonate (MFEC), difluoroethylene carbonate (DFEC), monofluoromethyl difluoromethyl carbonate (F-DMC), trifluorodimethyl carbonate (TFDMC), or the like. One of such nonaqueous solvents can be individually used or two or more thereof can be combined as appropriate and used.

As the supporting salt, a lithium salt, such as, for example, LiPF₆, LiBF₄, lithium-bis(fluorosulfonyl)imide (LiFSI), or the like, (preferably, LiPF₆), can be preferably used. A concentration of the supporting salt is preferably 0.7 mol/L or more and 1.3 mol/L or less.

Note that the nonaqueous electrolyte may include some other component than the above-described components, that is, for example, various types of additives, such as, for example, a film forming agent, such as oxalate complex or the like, a gas generating agent, such as biphenyl (BP), cyclohexylbenzene (CHB), or the like, a thickener, or the like, unless effects of the present disclosure are remarkably impaired.

Although not particularly limited, a viscosity of the nonaqueous electrolyte (nonaqueous electrolytic solution) can be generally about 10 to 100 mPa·s (for example, about 20 to 50 mPa·s). The viscosity can be measured by, for example, a commercially available viscometer.

As illustrated in FIG. 2, the positive electrode terminal 30 is inserted through a terminal insertion hole 18 formed in one end portion (a left end portion in FIG. 2) of the sealing plate 14 in the winding axis direction WD. The positive electrode terminal 30 is preferably formed of a metal, and is more preferably formed of, for example, aluminum or aluminum alloy. On the other hand, the negative electrode terminal 40 is inserted through a terminal insertion hole 19 formed in the other end portion (a right end portion in FIG. 2) of the sealing plate 14 in the winding axis direction WD. Note that the negative electrode terminal 40 is preferably formed of a metal, and is more preferably formed of, for example, copper or copper alloy. Herein, each of the electrode terminals (the positive electrode terminal 30 and the negative electrode terminal 40) protrudes from the same surface of the case 10 (specifically, the sealing plate 14). However, the positive electrode terminal 30 and the negative electrode terminal 40 may be formed to protrude from different surfaces of the case 10. The electrode terminals (the positive electrode terminal 30 and the negative electrode terminal 40) inserted into the terminal insertion hole 18 and the terminal insertion hole 19, respectively, are preferably fixed to the sealing plate 14 by a caulking work or the like.

As described above, the positive electrode terminal 30 is electrically connected to the positive electrode 22 of each of the wound electrode bodies 20a, 20b, and 20c (see FIG. 7) via the positive electrode current collector 50 (the positive electrode first current collector 51 and the positive electrode second current collector 52) in the case body 12, as illustrated in FIG. 2. The positive electrode terminal 30 is insulated from the sealing plate 14 by the positive electrode internal insulating member 70 and the gasket 90. Note that the positive electrode internal insulating member 70 includes a base portion 70a arranged between the positive electrode first current collector 51 and the sealing plate 14 and a protruding portion 70b protruding from the base portion 70a toward the wound electrode body 20a. The positive electrode terminal 30 exposed to outside of the case 10 through the terminal insertion hole 18 is connected to the positive electrode external conductive member 32 outside the sealing plate 14. On the other hand, as illustrated in FIG. 2, the negative electrode terminal 40 is electrically connected to the negative electrode 24 of each of the wound electrode bodies 20a, 20b, and 20c (see FIG. 7) via the negative electrode current collector 60 (the negative electrode first current collector 61 and the negative electrode second current collector 62) in the case body 12. The negative electrode terminal 40 is insulated from the sealing plate 14 by the negative electrode internal insulating member 80 and the gasket 90. Note that, similar to the positive electrode internal insulating member 70, the negative electrode internal insulating member 80 includes a base portion 80a arranged between the negative electrode first current collector 61 and the sealing plate 14 and a protruding portion 80b protruding from the base portion 80a toward the wound electrode body 20a. The negative electrode terminal 40 exposed to outside of the case 10 through the terminal insertion hole 19 is connected to the negative electrode external conductive member 42 outside the sealing plate 14. The external insulating member 92 is arranged between each of the external conductive members (the positive electrode external conductive member 32 and the negative electrode external conductive member 42) described above and an outer surface of the sealing plate 14. The external conductive members 32 and 42 can be insulated from the sealing plate 14 by the external insulating member 92.

The protruding portions 70b and 80b of the internal insulating members (the positive electrode internal insulating member 70 and the negative electrode internal insulating member 80) described above are arranged between the sealing plate 14 and the wound electrode body 20a. With the protruding portions 70b and 80b of the internal insulating members, upward movement of the wound electrode body 20a is restricted, and the sealing plate 14 and the wound electrode body 20a can be prevented from contacting each other.

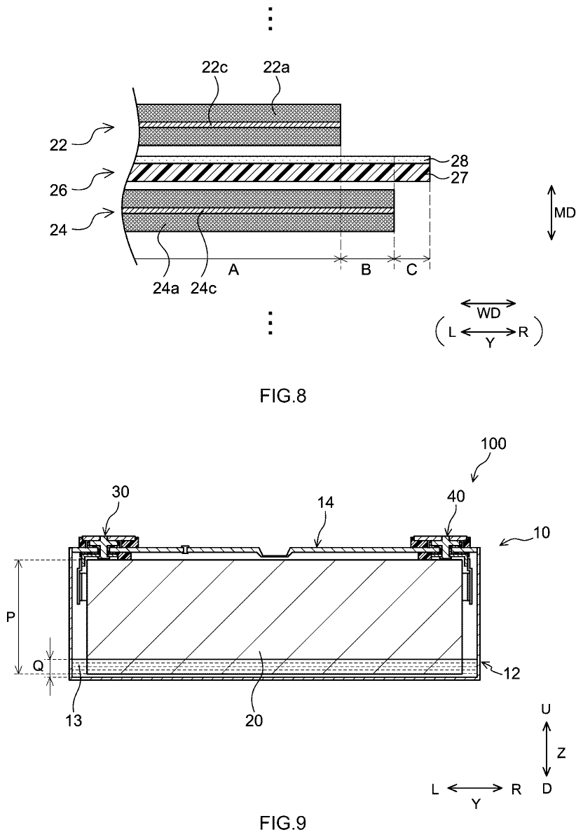

Subsequently, a configuration that characterizes the battery 100 according to this preferred embodiment will be described. First, as described above, the battery 100 according to this preferred embodiment includes the wound electrode bodies 20a, 20b, and 20c each being configured such that the strip-shaped positive electrode 22 and the strip-shaped negative electrode 24 are wound with the strip-shaped separator 26 interposed therebetween, the electrolytic solution 13, and the case 10 that accommodates the wound electrode bodies 20a, 20b, and 20c and the electrolytic solution 13. The positive electrode 22 includes the positive electrode active material layer 22a, and the negative electrode 24 includes the negative electrode active material layer 24a. The length of the negative electrode active material layer 24a (corresponding to S in FIG. 7) in a direction (corresponding to the width direction, that is, the winding axis direction WD in FIG. 7) in which the winding axis WL of each of the wound electrode bodies 20a, 20b, and 20c extends is 200 mm or more. The infiltration speed of the nonaqueous electrolytic solution in the negative electrode active material layer 24a is 0.02 μL/s to 0.05 μL/s. On at least one side in the winding axis direction WD (a right side in FIG. 8), a distance between an end portion of the positive electrode active material layer 22a and an end portion of the negative electrode active material layer 24a (corresponding to B in FIG. 8) is more than 0 mm and 5 mm or less. In a fully charged state (that is, a state where SOC is 100%), a ratio (V_{L}/V_{V}) of a volume V_{L} of the nonaqueous electrolytic solution to a total void volume V_{V} of the positive electrode active material layer 22a and the negative electrode active material layer 24a in each of the wound electrode bodies 20a, 20b, and 20c is 130% or less.

According to the study of the present inventor, it is understood that, particularly in the large-size nonaqueous electrolyte secondary battery described above, with a large electrode width, the moving path of the aqueous electrolytic solution (a path between a center of an electrode body to outside of the electrode body) is increased, and a high-rate characteristic is likely to be reduced (in other words, high-rate deterioration is likely to occur). In this case, the high-rate deterioration can occur due to the following causes. First, in performing charging of a battery, electrodes expand and, under an environment where change of the battery in a thickness direction is limited (for example, in a state where the battery is in a battery case, a state where an external pressure is applied in order to suppress expansion and contraction of the battery, or the like), the nonaqueous electrolytic solution included between the electrodes is pushed out. In performing discharging of the battery, the electrodes contact and the pushed out nonaqueous electrolytic solution returns. However, when charging is started again before the pushed out nonaqueous electrolytic solution has completely returned, the nonaqueous electrolytic solution is pushed out again. As this is repeated, movement of the nonaqueous electrolytic solution cannot catch up with expansion and contraction of the electrodes, so that a concentration gradient is caused in the nonaqueous electrolytic solution (in other words, a salt concentration unevenness occurs). By the concentration gradient, a portion having a high resistance is generated (for example, in both end portions of a wound electrode body in a winding axis direction) in the battery, and there arises a probability that Li deposition and deterioration of an electrode active material occur from the portion. In the above-described manner, high-rate deterioration can occur. According to the study of the present inventor, it is understood that, the more portions where a supporting salt in the nonaqueous electrolytic solution is dispersed (for example, the nonaqueous electrolytic solution, electrode non-opposed regions where a positive electrode and a negative electrode are not opposed, or the like) are present, the more likely the high-rate deterioration is to occur. For example, in FIG. 8, an electrode opposed region where the positive electrode 22 and the negative electrode 24 are opposed to each other is denoted by A, an electrode non-opposed region where the positive electrode 22 and the negative electrode 24 are not opposed to each other is denoted by B, and a region where no electrode is present is denoted by C. Particularly, in the region B, the nonaqueous electrolytic solution is likely to accumulate and the supporting salt is likely to be dispersed. It is understood that, in a central portion of the wound electrode body and end portions thereof in the winding axis direction, the salt concentration unevenness is more likely to occur. It is also understood that the salt concentration unevenness is also related to an infiltration speed (a soaking speed) of the electrodes and there is a tendency that, when a negative electrode where the infiltration speed is low is used, the salt concentration unevenness is likely to occur. A possible cause for this is that, in the negative electrode where the infiltration speed of the nonaqueous electrolytic solution is low, high-rate deterioration is likely to occur because the nonaqueous electrolytic solution does not return.

Therefore, the present inventor focused on a nonaqueous electrolyte secondary battery including a wound electrode body in which the above-described high-rate deterioration was likely to occur, a length of a negative electrode active material in a winding axis direction of a negative electrode material layer was 200 mm or more, and an infiltration speed of a nonaqueous electrolytic solution in the negative electrode active layer was 0.02 μL/s to 0.05 μL/s. As a result of an earnest examination, the present inventor has found that high-rate deterioration is preferably suppressed by setting an amount of the nonaqueous electrolytic solution to an appropriate amount (specifically, in the fully charged state (that is, the state where SOC is 100%), a ratio of a volume of the nonaqueous electrolytic solution to a total void volume of a positive electrode active material layer and the negative electrode material layer in the wound electrode boy to 130% or less, and an electrode non-opposed region where a positive electrode and a negative electrode are not opposed to each other to an appropriate range (specifically, setting a distance between an end portion of the positive electrode and an end portion of the negative electrode active material layer to a distance that is more than 0 mm and 5 mm or less on at least one side in the winding axis direction) to complete the present disclosure. Note that the description above is a consideration of the present inventor based on results of experiments, and the technology disclosed herein should not be interpreted with a limitation to the description above.

As described above, from a viewpoint of being preferable as an object to which the technology of the present disclosure is applied (in other words, in which high-rate deterioration is likely to occur), the length of the negative electrode active material layer 24a in the winding axis direction WD of the wound electrode body 20a (20b, 20c) (corresponding to S in FIG. 7) is specified to 200 mm or more. From a viewpoint of being more preferable as a mode in which the technology of the present disclosure is applied, the length S of the negative electrode active material layer 24a is preferably 300 mm or more, and may be, for example, 400 mm or more. An upper limit of the length S of the negative electrode active material layer 24a is, for example, 600 mm or less, and may be 500 mm or less. Note that the length S of the negative electrode active material layer 24a can be measured by, for example, a ruler or the like.

As described above, from the viewpoint of being preferable as an object to which the technology of the present disclosure is applied, the infiltration speed of the nonaqueous electrolytic solution in the negative electrode active material layer 24a is specified to 0.02 μL/s to 0.05 μL/s. From the viewpoint of being more preferable as a mode in which the technology of the present disclosure is applied, the infiltration speed is preferably 0.03 μL/s to 0.05 μL/s. Note that, as to a method for measuring the infiltration speed of the nonaqueous electrolytic solution, for example, a corresponding column in examples that will be described later can be referred to. The infiltration speed of the nonaqueous electrolytic solution in the negative electrode active material layer 24a can be easily adjusted, for example, by changing the electrode density of the negative electrode active material layer 24a, or the like. As another option, the infiltration speed of the nonaqueous electrolytic solution in the negative electrode active material layer 24a can be easily adjusted also by changing a type of the negative electrode material as appropriate, or the like.

Herein, FIG. 8 is a schematic cross-sectional view taken along line VIII-VIII in FIG. 2. As described above, in the technology disclosed herein, from a viewpoint of preferably suppressing high-rate deterioration, the distance between the end portion of the positive electrode active material layer 22a and the end portion of the negative electrode active material layer 24a (corresponding to B in FIG. 8) is specified to a distance that is more than 0 mm and 5 mm or less on at least one side in the winding axis direction WD. The distance is preferably achieved on each of both sides (the right side and a left side in FIG. 8) in the winding axis direction WD. In the electrode non-opposed region of the negative electrode 24, since the positive electrode 22 opposed to the negative electrode 24 is not present and a pressure is less likely to be applied thereto, the nonaqueous electrolytic solution tends to be more easily retained than in the electrode opposed region. Therefore, the salt concentration unevenness can be reduced (that is, high-rate deterioration can be suppressed) by making the electrode-non opposed region as small as possible to reduce the amount of the nonaqueous electrolytic solution that can be retained in the electrode non-opposed region. The distance between the end portion of the positive electrode active material layer 22a and the end portion of the negative electrode active material layer 24a may be, for example, 1 mm or more and may be 1.5 mm or more. The upper limit of the distance may be, for example, 4 mm or less and may be 3 mm or less. The distance can be measured by, for example, a ruler or the like. As in this preferred embodiment, when the positive electrode 22 and the negative electrode 24 include the positive electrode tabs 22t and the negative electrode tabs 24t, respectively, the end portion of the positive electrode active material layer 22a and the end portion of the negative electrode active material layer 24a excluding the positive electrode tabs 22t and negative electrode tabs 24t are assumed as the end portion of the positive electrode active material layer 22a and the end portion of the negative electrode active material layer 24a. Note that, in FIG. 8, a base material layer is denoted by the reference numeral 27 and a heat resistance layer is denoted by the reference numeral 28.

Moreover, as described above, in the technology disclosed herein, from the viewpoint of preferably suppressing high-rate deterioration, in the fully charged state (that is, the state where SOC is 100%), the ratio of the volume of the nonaqueous electrolytic solution to the total void volume of the positive electrode active material layer 22a and the negative electrode active material layer 24a in the wound electrode body 20a (20b, 20c) is specified to 130% or less. In other words, in the fully charged state, when it is assumed that the total void volume of the positive electrode active material layer 22a and the negative electrode active material layer 24a in the wound electrode body 20a (20b, 20c) is 100%, the ratio of the volume of the nonaqueous electrolytic solution is specified to 130% or less. The volume of the nonaqueous electrolytic solution means a nonaqueous electrolytic solution existing inside and outside the wound electrode body in the fully charged state. When the amount of the nonaqueous electrolytic solution is too large, the nonaqueous electrolytic solution existing inside and outside the wound electrode body is increased, so that there arises a tendency that the supporting salt can easily escape. This not preferable. Therefore, the ratio of the volume of the nonaqueous electrolytic solution existing inside and outside the wound electrode body is specified to 130% or less. The ratio of the volume of the nonaqueous electrolytic solution may be, for example, 120% or less and may be 115% or less. From a viewpoint of achieving smooth progress of charging and discharging in the battery 100, a lower limit of the ratio of the volume of the nonaqueous electrolytic solution is preferably 100% or more.

Here, the total void volume (which will be hereinafter also referred to as a “volume of an electrode void”) of the positive electrode active material layer 22a and the negative electrode active material layer 24a can be obtained by measurement by, for example, a mercury penetration porosimeter and calculation from an electrode density and a true density of an electrode active material and an auxiliary material. Measurement by the mercury penetration porosimeter can be performed in accordance with a known method for this kind. A method for calculating the total void volume from the electrode density and the true density of an electrode active material and an auxiliary material can be performed, for example, in the following manner. Specifically, a volume of a void of the negative electrode active material layer 24a can be calculated by dividing a weight of the negative electrode active material layer 24a by a value obtained by subtracting a density of the negative electrode active material layer 24a from a true density of the negative electrode material and an auxiliary material (for example, various additives other than the negative electrode active material) forming the negative electrode active material layer 24a. A volume of a void of the positive electrode active material layer 22a can be calculated by dividing a weight of the positive electrode active material layer 22a by a value obtained by subtracting a density of the positive electrode active material layer 22a from a true density of the positive electrode material and an auxiliary material (for example, various additives other than the positive electrode active material) forming the positive electrode active material layer 22a. Then, the volume of the void of the negative electrode active material layer 24a and the volume of the void of the positive electrode active material layer 22a can be summed up to obtain the total void volume (the volume of the electrode void). Note that, when a plurality of wound electrode bodies are accommodated in one battery case, the total void volume is a total of volumes of electrode voids of all the wound electrode bodies. For example, as illustrated in FIG. 3 to FIG. 6, when the three wound electrode bodies 20a, 20b, and 20c are accommodated in the case 10, a total of volumes of electrode voids of the three wound electrode bodies 20a, 20b, and 20c is the total void volume.

Moreover, for example, for a pre-assembled battery, a volume of a nonaqueous electrolytic solution/a volume of an electrode void (%) can be calculated in the following manner. First, in the fully charged state, the battery is disassembled, the (excessive) non-aqueous electrolytic solution outside a wound electrode body is collected, and a volume thereof is measured. For the nonaqueous electrolytic solution inside the wound electrode body, a volume thereof is calculated from a weight difference between before and after drying of the wound electrode body. Note that, as to a method for determining the weight difference between before and after drying, since there is a probability that, when the wound electrode body is dried as it is, the supporting salt remains in the wound electrode body, it is preferable to, after measuring the weight before drying, wash the wound electrode body with a solvent (for example, dimethyl carbonate (DMC), or the like) to achieve a state where the support salt does not remains, and thereafter, dry the wound electrode body, and then, measure the weight. The volume of the nonaqueous electrolytic solution can be calculated by summing up the volume of the nonaqueous electrolytic solution outside the wound electrode body and the volume of the wound electrode body calculated from the weight difference between before and after drying. Note that, as the volume of the nonaqueous electrolytic solution, a value obtained by measurement performed at room temperature (for example, 25° C.) can be employed. For the wound electrode body after drying described above, the volume of the electrode void can be measured using the mercury penetration porosimeter or the like.

For example, examples of a method for making the volume of the nonaqueous electrolytic solution/the volume of the electrode void (%) X % when the battery is fully charged (that is, the state where SOC is 100%) include the following method. First, a density of the electrode void is calculated by the above-described method in advance, the nonaqueous electrolytic solution is injected such that the volume of the nonaqueous electrolytic solution/the volume of the electrode void (%) is X % at injection. Thus, the nonaqueous electrolytic solution can be adjusted such that the volume of the nonaqueous electrolytic solution/the volume of the electrode void=X % is achieved when the battery is fully charged.

In one preferred aspect, the ratio of the volume of the nonaqueous electrolytic solution to a volume of a space inside the case 10 in the fully charged state (that is, the state where SOC is 100%) is 65% or more and 80% or less. The volume of the nonaqueous electrolytic solution means the nonaqueous electrolytic solution that exists inside and outside the wound electrode body in the fully charged state. According to the above-described configuration, an amount of the supporting salt that escapes into the nonaqueous electrolytic solution that exists inside and outside the wound electrode body can be preferably suppressed, and therefore, the above-described configuration is preferable from the viewpoint of suppressing high-rate deterioration. The ratio of the volume of the nonaqueous electrolytic solution may be, for example, 70% or more, and may be 77% or less (for example, 75% or less). Note that the volume of the space inside the case 10 is a value obtained by subtracting volumes of the wound electrode bodies 20a, 20b, and 20c, a volume of each member (for example, an electrode current collector, an insulating member, or the like) present in the case 10, and the volume of the nonaqueous electrolytic solution from a total of the volume of the case 10, the volume of the electrode void, and a volume of a void in the separator 26. As the volume of the nonaqueous electrolytic solution, a value of a volume measured at, for example, room temperature (for example, 25° C.) after disassembling the battery in the fully charged state and collecting the nonaqueous electrolytic solution inside and outside the wound electrode body can be employed.

For example, examples of a method for making the volume of the nonaqueous electrolytic solution/the volume of the space of the battery case (%) Y % when the battery is fully charged (that is, the state where SOC is 100%) include the following method. First, the volume of the space in the battery case is calculated by the above-described method in advance, the nonaqueous electrolytic solution is injected such that the volume of the nonaqueous electrolytic solution/the volume of the space of the battery case (%) is Y % at injection. Thus, the nonaqueous electrolytic solution can be adjusted such that the volume of the nonaqueous electrolytic solution/the volume of the space in the battery case=Y % is achieved when the battery is fully charged.

Herein, FIG. 9 is a view illustrating a relationship between a liquid level height of a nonaqueous electrolytic solution 13 and a height of the wound electrode body 20a (20b, 20c). Note that, as to the height of the wound electrode body 20a (20b, 20c), when the wound electrode body 20a is placed in the case body 12 such that the bottom wall 12a is located immediately under the wound electrode body 20a in a vertical direction and the first side walls 12b and the second side walls 12c extend in the vertical direction, a lower end is 0% and an upper end is 100% in the vertical direction. The height of the wound electrode body 20a (20b, 20c) can be also referred to as, for example, a length of the wound electrode body 20a in a direction perpendicular to the winding axis direction WD and perpendicular to a thickness direction X. In one preferred aspect, in the fully charged state (that is, the state where SOC is 100%), when it is assumed that the height of the wound electrode bodies 20a (20b, 20c) (corresponding to P in FIG. 9) is 100%, the liquid level height of the nonaqueous electrolytic solution 13 (corresponding to Q in FIG. 9) is 10% or less. When an amount of the nonaqueous electrolytic solution 13 existing outside the wound electrode body 20a (20b, 20c) is large, the supporting salt can easily escape accordingly, and therefore, from the viewpoint of suppressing high-rate deterioration, it is not preferable that the amount of the nonaqueous electrolytic solution 13 is large. Therefore, as described above, for example, when the battery is fully charged, it is preferable that a liquid level height Q of the nonaqueous electrolytic solution 13 is adjusted to an appropriate range (in other words, the amount of the nonaqueous electrolytic solution 13 existing outside the wound electrode bodies 20a, 20b, and 20c is adjusted to an appropriate range). In view of the foregoing, in the fully charged state, the liquid level height Q of the above nonaqueous electrolytic solution 13 is more preferably 7% or less, and is further more preferably 5% or less or 3% or less. In addition, in the fully charged state, the liquid level height Q of the above nonaqueous electrolytic solution 13 can be, for example, 0.5% or more and can be 1% or more. Note that those skilled in the art can adjust the liquid level height Q of the nonaqueous electrolytic solution 13 to 10% or less, when it is assumed that the height of the wound electrode body 20a (20b, 20c) is 100%, in the fully charged state (that is, the state where SOC is 100%) by adjusting the amount of the nonaqueous electrolytic solution 13 that is injected at injection by conducting a preliminary test or the like in advance. In this preferred embodiment, the positive electrode tab group 23 and the negative electrode tab group 25 are located above the liquid level height Q of the nonaqueous electrolytic solution 13 and are not immersed in the nonaqueous electrolytic solution 13.

In one preferred aspect, in a state where SOC is 20% (at discharging), when the height of the wound electrode body 20a (20b, 20c) (corresponding to P in FIG. 9) is 100%, the liquid level height of the nonaqueous electrolytic solution 13 (corresponding to Q in FIG. 9) is preferably lower than that in the fully charged state, and is, for example, 7% or less. When the amount of the nonaqueous electrolytic solution 13 existing outside the wound electrode body 20a, 20b, 20c is large, the supporting salt can easily escape accordingly, and therefore, from the viewpoint of suppressing high-rate deterioration, it is not preferable that the amount of the nonaqueous electrolytic solution 3 is large. Therefore, as described above, it is preferable that the liquid level height Q of the nonaqueous electrolytic solution 13 is adjusted to an appropriate range (in other words, the amount of the nonaqueous electrolytic solution 13 existing outside the wound electrode bodies 20a, 20b, and 20c is adjusted to an appropriate range), for example, in the state where SOC is 20%. In view of the foregoing, in the state where SOC is 20%, the liquid level height Q of the nonaqueous electrolytic solution 13 is preferably 5% or less, and is more preferably 3% or less to 1% or less. In addition, in the state where SOC is 20%, the liquid level height Q of the above nonaqueous electrolytic solution 13 can be, for example, 0.1% or more and can be 0.5% or more. The liquid level height of the nonaqueous electrolytic solution 13 in the state where SOC is 20% is preferably measured when movement of the nonaqueous electrolytic solution is completely finished, for example, after a sufficient time (for example, about one hour) has elapsed since an end of charging and discharging. Note that, those skilled in the art can adjust the liquid level height of the nonaqueous electrolytic solution 13 to 7% or less, when it is assumed that the height of the wound electrode body 20a (20b, 20c) is 100%, in the state where SOC is 20% (at discharging) by adjusting the amount of the nonaqueous electrolytic solution that is injected at injection by conducting a preliminary test or the like in advance.

The liquid level height Q of the nonaqueous electrolytic solution in the fully charged state (or in the state where SOC is 20%) can be measured by performing a CT scan or the like on the battery 100.

Although the technology disclosed herein can be applied to, for example, other batteries than large-size batteries, large-size batteries (for example, high-capacity batteries) are particularly preferable as objects to which the technology disclosed herein is applied. Herein, examples of outer dimensions of a wound electrode body of such a large-size battery include a height: 50 mm to 100 mm, a width: 200 mm to 300 mm, and a depth: 10 mm to 40 mm. Note that the height, the width, and the depth can be described as a length of the wound electrode body 20a in the short side direction (a length in the direction Z in FIG. 7), a length of the wound electrode body 20a in the long side direction (a length in the direction Y in FIG. 7), and a thickness of the wound electrode body 20a (a thickness in the direction X in FIG. 6), respectively, when the wound electrode body is described using the wound electrode body 20a as an example. A capacity of the battery 100 is, for example, 50 Ah or more, preferably 100 Ah or more, and can be 150 Ah or more or 200 Ah or more.

### <Method for Manufacturing Battery>

Next, an example of a method for manufacturing the battery 100 according to this preferred embodiment will be described. In manufacturing the battery 100 according to this preferred embodiment, it is characterized that the length of the negative electrode active material layer 24a in the winding axis direction WD is 200 mm or more, the infiltration speed of the nonaqueous electrolytic solution in the negative electrode active material layer 24a is 0.02 μL/s to 0.05 μL/s, and the distance between the end portion of the positive electrode active material layer 22a and the end portion of the negative electrode active material layer 24a is more than 0 mm and 5 mm or less on at least one side in the winding axis direction WD. The battery 100 according to this preferred embodiment can be manufactured, for example, by preparing the wound electrode bodies 20a, 20b, and 20c, inserting the wound electrode bodies 20a, 20b, and 20c in the case 10, and sealing the case 10. More specifically, first, as illustrated in FIG. 5, the positive electrode second current collector 52 is joined to the positive electrode tab group 23 of each of the electrode bodies and the negative electrode second current collector 62 is joined to the negative electrode tab group 25 thereof. Then, as illustrated in FIG. 4, the electrode bodies are aligned such that flat portions thereof are opposed to each other. The sealing plate 14 is arranged above the electrode bodies, and the positive tab group 23 of each of the electrode bodies is bent such that the positive electrode second current collector 52 and one side surface 20e of the electrode body are opposed to each other. Thus, the positive electrode first current collector 51 and the positive electrode second current collector 52 are connected to each other. Similarly, the negative electrode tab group 25 of each of the electrodes is bent such that the negative electrode second current collector 62 and the other side surface 20h of the electrode body are opposed to each other. Thus, the negative electrode first current collector 61 and the negative electrode second current collector 62 are connected to each other. As a result, the electrode body is attached to the sealing plate 14 via the positive electrode current collector 50 and the negative electrode current collector 60. Next, the electrode bodies attached to the sealing plate 14 are covered by an electrode body holder 29 (see FIG. 3) and then are accommodated inside the case body 12. As a result, flat portions of the electrode bodies are opposed to the long side walls 12b of the case body 12 (that is, flat surfaces of the case 10). An upper curved portion 20r is opposed to the sealing plate 14, and a lower curved portion 20r is opposed to the bottom wall 12a of the case body 12. The case 10 is constructed by joining (welding) the case body 12 and the sealing plate 14 after closing the opening 12h in the upper surface of the case body 12 with the sealing plate 14. Thereafter, only a predetermined amount of a nonaqueous electrolytic solution is injected into the case 10 through a liquid injection hole 15 in the sealing plate 14, and the liquid injection hole 15 is closed with the sealing member 15a. The battery 100 can be manufactured in the above-described manner.

### <Application of Battery>

The battery 100 can be used for various applications, and can be preferably used as a power source (a drive power source) for a motor mounted on a vehicle, such as, for example, a passenger vehicle, a truck, or the like. There is no particular limitation on a vehicle type. Examples of the vehicle type include, for example, a plug-in hybrid electric vehicle (PHEV), a hybrid electric vehicle (HEV), a battery electric vehicle (BEV), or the like. In the battery 100, variations in battery reaction are reduced, and therefore, the battery 100 can be preferably used for constructing an assembled battery.

One preferred embodiment of the present disclosure has been described above, but the preferred embodiment is merely an example. The present disclosure can be implemented in various other embodiments. The present disclosure can be carried out based on contents disclosed in this specification and the common general technical knowledge in the field. The technology described in the scope of claims includes various modifications and changes of the preferred embodiment described as an example above. For example, a portion of the preferred embodiment described above can be replaced with some other modified aspect. Some other modified aspect can be added to the preferred embodiment described above. Additionally, a technical feature can be deleted as appropriate unless the technical feature is described as an essential element.

As described above, the following items are given as specific aspects of the technology disclosed herein.

First Item: A nonaqueous electrolyte secondary battery that includes a wound electrode body configured such that a strip-shaped positive electrode and a strip-shaped negative electrode are wound with a strip-shaped separator interposed therebetween, a nonaqueous electrolytic solution, and a battery case that accommodates the wound electrode body and the nonaqueous electrolytic solution, and in which the positive electrode includes a positive electrode active material layer, the negative electrode includes a negative electrode active material layer, a length of the negative electrode active material layer in a winding axis direction of the wound electrode body is 200 mm or more, an infiltration speed of the nonaqueous electrolytic solution in the negative electrode active material layer is 0.02 μL/s or more and 0.05 μL/s or less, a distance between an end portion of the positive electrode active material layer and an end portion of the negative electrode active material layer is more than 0 mm and 5 mm or less on at least one side in the winding axis direction, and, in a fully charged state, a ratio of a volume of the nonaqueous electrolytic solution to a void volume of the positive electrode active layer and the negative electrode active layer in the wound electrode body is 130% or less.
Second Item: The nonaqueous electrolyte secondary battery according to the first item, in which, in the fully charged state, a ratio of the volume of the nonaqueous electrolytic solution to a volume of a space in the battery case is 65% or more and 80% or less.
Third Item: The nonaqueous electrolyte secondary battery according to the first or second item, in which, in the fully charged state, when it is assumed that a height of the wound electrode body is 100%, a liquid level height of the nonaqueous electrolytic solution is 10% or less.
Fourth Item: The nonaqueous electrolyte secondary battery according to any one of the first to third items, in which, in a state where a charging depth (SOC) is 20%, when it is assumed that a height of the wound electrode body is 100%, a liquid level height of the nonaqueous electrolytic solution is 7% or less.

Test examples related to the present disclosure will be described below, but the test examples are not intended to be particularly limiting the present invention.

### Test Examples

### <Manufacturing of Each Sample>

### (Forming of Separator)

As a separator, a wet-type microporous polyethylene sheet having a thickness of 12 μm was prepared. A heat resistance layer having a thickness of 2 μm was formed on both surfaces of a separator.

### (Manufacturing of Negative Electrode Plate>

Graphite as a negative electrode active material, styrene butadiene rubber (SRB) as a binder, and carboxymethyl cellulose (CMC) were mixed such that a weight ratio of the negative active material:CMC:SBR=98.3:0.7:1 was achieved and an appropriate amount of ion exchange water as a solvent was added thereto to prepare a negative electrode active material forming slurry. Thereafter, drying and roll pressing were performed thereon to obtain a negative electrode plate. Note that, for each sample, a press pressure of the roll pressing was changed to cause an electrode density of a negative electrode active material layer to differ among samples, so that an infiltration speed of a nonaqueous electrolytic solution was adjusted to an infiltration speed indicated in Table 1.

Note that the infiltration speed of the nonaqueous electrolytic solution in the negative electrode active material layer was measured in the following manner. Specifically, at room temperature (for example, 25° C.) and under a predetermined pressure (for example, under 0.1 MPa), 1 μL of the nonaqueous electrolytic solution was dropped on one surface of the negative electrode active material layer by a microsyringe, a time that it took for droplets of the nonaqueous electrolytic solution to soak into the negative electrode active material layer (that is, a time up to when there was no longer the droplets on the negative electrode active material layer) was measured, and a soaking speed at which 1 μL of the nonaqueous electrolytic solution soaked into the negative electrode active material layer was calculated.

### (Manufacturing of Positive Electrode Plate)

Lithium nickel cobalt manganese composite oxide (LiNi_{0.6}Co_{0.2}Mn_{0.2}O₂, NCM622) as a positive electrode active material, acetylene black (AB) as a conductive material, and polyvinylidene fluoride (PVdF) as a binder were mixed such that the positive active material:the conductive material:the binder=97.5:1.5:1 was achieved, and an appropriate amount of N-methyl-2-pyrrolidone (NMP) as a solvent was added thereto to prepare a positive electrode active material forming slurry. The positive electrode active material forming slurry was applied to a positive electrode current collector formed of an aluminum foil such that a basis weight thereof was 10 mg/cm². Thereafter, drying and roll pressing were performed thereon to obtain a positive electrode plate.

Next, the positive electrode plate and the negative electrode plate were stacked with separators interposed therebetween and an obtained stacked body was pressed into a flat shape to obtain a wound electrode body. As two separators, separators both manufactured in the above-described manner were used. Note that, for each sample, a distance between an end portion of the positive electrode active material layer and an end portion of the negative electrode active material layer was adjusted to a distance indicated in Table 1. Then, after welding a current collector plate to the wound electrode body, the wound electrode body was accommodated in a rectangular battery case and a nonaqueous electrolytic solution was injected. As the nonaqueous electrolytic solution, LiPF₆ as a supporting salt was dissolved at a centration of 1.1 mol/L into a mixed solvent containing ethylene carbonate (EC), ethyl methyl carbonate (EMC), and dimethyl carbonate (DMC) at a volume ratio of EC:EMC:DMC=3:4:3. Note that, for each sample, the nonaqueous electrolytic solution was injected such that a volume of the nonaqueous electrolytic solution/a volume of an electrode void (%) was a value indicated in Table 1 at injection. The volume of the electrode void was calculated from a density of an electrode active material layer and a true density of an electrode active material and an auxiliary material, as described above. Thereafter, the battery case was sealed to obtain an evaluation lithium-ion secondary battery for each sample. Note that the volume of the nonaqueous electrolytic solution/a volume of a space in the battery case (%) was calculated from the space in the battery case and a volume of the injected nonaqueous electrolytic solution that had been measured in advance. Results are indicated in a column of “Volume of Nonaqueous Electrolytic Solution/Volume of Space in Battery Case [%]” in Table 1.

### <Evaluation of Each Evaluation Lithium-Ion Secondary Battery>

Each evaluation lithium-ion secondary battery manufactured in the above-described manner was placed in a thermostatic bath at 25° C., and initial charging was performed. For the initial charging, each evaluation lithium-ion secondary battery was charged with a constant current at a current value of 0.3 C to 4.1 V. Thereafter, the lithium-ion secondary battery was discharged with a constant current at a current value of 0.3 C to 3.0 V. Furthermore, constant current-constant voltage charging was performed (after constant current charging at a current value of 0.2 C to 4.1 V was performed, constant voltage charging was performed until the current value became 1/50 C) on the evaluation lithium-ion secondary battery to achieve a fully charged state thereof. Thereafter, constant current discharging was performed at a current value of 0.2 C to 3.0 V. A discharge capacity then was measured, and a measurement value was set as an initial capacity.

### (Evaluation of Cycle Characteristic)

Each evaluation lithium-ion secondary battery was placed in a thermostatic bath at 25° C. For each evaluation lithium-ion secondary battery, charging and discharging where constant current charging at 2 C to 4.1 V and constant current discharging at 2 C to 3.0 V were set as one cycle were repeated for 200 cycles. Thereafter, the discharge capacity was measured in the same manner as described above, and the discharge capacity then was determined as a battery capacity after 200 cycles of charging and discharge. A capacity retention rate (%) was determined in accordance with (the battery capacity after 200 cycles of charging and discharging/the initial capacity)×100. Results are indicated in a column of “Cycle Characteristic” in Table 1.

### (Evaluation of High-Rate Characteristic)

To evaluate a high-rate characteristic (a high-rate resistance) of each evaluation lithium-ion secondary battery, a resistance increase rate (%) was measured. The measurement was performed at 25° C. Specifically, after adjusting SOC of each evaluation lithium-ion secondary battery to 60%, a high-rate cycle test in which a charging and discharging cycle including charging at a constant current of 10 C (40 A) for 10 seconds and discharging at a constant current of 2 C (8 A) for 400 seconds was repeated 30 times was performed. The resistance increase rate (=[an IV resistance after the high-rate cycle test/an initial IV resistance]×100) was calculated based on the IV resistance after the high-rate cycle test and the initial IV resistance. Note that the IV resistance was determined from an inclination of a linear approximate straight line of a current (I)-voltage (V) plot value when discharging at 10 C for 10 seconds was performed. The measurement was performed at room temperature (for example, 25° C.). Results are indicated in a column of “Resistance Increase Rate” in Table 1. Based on values of the resistance increase rate, evaluation of the high-rate characteristic was performed. Specifically, a case where the resistance increase rate was 1.05 times or less was evaluated as “Very Good,” a case where the resistance increase rate was more than 1.05 times and less than 1.10 times was evaluated as “Good,” and a case where the resistance increase rate was 1.10 times or more was evaluated as “Poor.” Results are indicated in a column of “High-rate Characteristic” in Table 1.

TABLE 1

| | Volume of | Distance between End | Volume of | Infiltration Speed | | | Cycle |
|---|---|---|---|---|---|---|---|
| | Nonaqueous | Portion of Positive | Nonaqueous | of Nonaqueous | | | Characteristic |
| | Electrolytic | Electrode Active Material | Electrolytic | Electrolytic Solution | | | (200 Cycle |
| | Solution/Volume | Layer and End Portion | Solution/Volume of | in Negative | Resistance | High- | Capacity |
| | of Electrode | of Negative Electrode | Space in Battery | Electrode Active | Increase | rate | Retention |
| | Void [%] | Material [mm] | Case [%] | Material Layer [μL/s] | Rate | Characteristic | Rate) [%] |
| Sample 1 | 120 | 3 | 70 | 0.03 | 1.05 | Very Good | 95 |
| Sample 2 | 115 | 1.5 | 65 | 0.03 | 1.05 | Very Good | 95 |
| Sample 3 | 130 | 5 | 77 | 0.03 | 1.07 | Good | 95 |
| Sample 4 | 130 | 4 | 77 | 0.05 | 1.03 | Very Good | 93 |
| Sample 5 | 140 | 3 | 83 | 0.03 | 1.15 | Poor | 95 |
| Sample 6 | 120 | 6 | 70 | 0.03 | 1.11 | Poor | 95 |
| Sample 7 | 140 | 6 | 83 | 0.07 | 1.02 | Very Good | 92 |
| Sample 8 | 120 | 3 | 70 | 0.07 | 1.01 | Very Good | 92 |

It was confirmed that, as indicated in Table 1, according to the evaluation lithium-ion secondary batteries of Samples 1 to 4 in which the length of the negative electrode active material layer in the winding axis direction was 200 mm or more, the infiltration speed of the nonaqueous electrolytic solution in the negative electrode active material layer was 0.02 μL/s to 0.05 μL/s, the distance between the end portion of the positive electrode active material layer and the end portion of the negative electrode active material layer on each of both side in the winding axis direction was more than 0 mm and 5 mm or less, and in the fully charged state, the ratio of the nonaqueous electrolytic solution to the total void volume of the positive electrode active material layer and the negative electrode active material layer in the wound electrode body was 130% or less (or, in the fully charged state, the ratio of a volume of the nonaqueous electrolytic solution to the space in the battery case was in a range of 65% to 80%), high-rate deterioration could be more preferably suppressed, as compared to the evaluation lithium-ion secondary battery of Sample 5 in which, in the fully charged state, the ratio of the nonaqueous electrolytic solution to the total void volume of the positive electrode active material layer and the negative electrode active material layer in the wound electrode body was more than 130% (or, in the fully charged state, the ratio of the volume of the nonaqueous electrolytic solution to the space in the battery case was out of the range of 65% to 80%) and the evaluation lithium-ion secondary battery of Sample 6 in which the distance between the end portion of the positive electrode active material layer and the end portion of the positive electrode active material layer was more than 5 mm in the winding axis direction.

In the evaluation lithium-ion secondary batteries of Samples 7 and 8, the infiltration speed of the non-aqueous electrolytic solution in the negative electrode active material layer was excellent, that is, 0.07 μL/s, indicating that there was no problem in the high-rate characteristic (a high-rate resistance). That is, a nonaqueous electrolyte secondary battery in which the infiltration speed of the nonaqueous electrolytic solution in the negative electrode active material layer is less than 0.07 μL/s (specifically, 0.02 μL/s to 0.05 μL/s) is preferable as an object to which the technology disclosed herein is applied. On the other hand, with regard to the cycle characteristic (in this case, the capacity retention after 200 cycles), it can be understood that there was a problem because the cycle characteristic was lower than those of the evaluation lithium-ion secondary batteries of Samples 1 to 4.

Although the preferred embodiment of the present application has been described thus far, the foregoing embodiment is only illustrative, and the present application may be embodied in various other forms. The present application may be practiced based on the disclosure of this specification and technical common knowledge in the related field. The techniques described in the claims include various changes and modifications made to the embodiment illustrated above. Any or some of the technical features of the foregoing embodiment, for example, may be replaced with any or some of the technical features of variations of the foregoing embodiment. Any or some of the technical features of the variations may be added to the technical features of the foregoing embodiment. Unless described as being essential, the technical feature(s) may be optional.

### DESCRIPTION OF REFERENCE CHARACTERS

10 Battery case
12 Case body
14 Sealing plate
15 Liquid injection hole
15a Sealing member
17 Gas exhaust valve
18, 19 Terminal insertion hole
20 Electrode body group
20a to 20c Wound electrode body
22 Positive electrode
23 Positive electrode tab group
24 Negative electrode
25 Negative electrode tab group
26 Separator
27 Base material layer
28 Heat resistance layer
30 Positive electrode terminal
32 Positive electrode external conductive member
40 Negative electrode terminal
42 Negative electrode external conductive member
50 Positive electrode current collector
60 Negative electrode current collector
70 Positive electrode internal insulating member
80 Negative electrode internal insulating member
90 Gasket
92 External insulating member
100 Battery (nonaqueous electrolyte secondary battery)

What is claimed is:

1. A nonaqueous electrolyte secondary battery comprising:
a wound electrode body configured such that a strip-shaped positive electrode and a strip-shaped negative electrode are wound with a strip-shaped separator interposed therebetween;
a nonaqueous electrolytic solution; and
a battery case that accommodates the wound electrode body and the nonaqueous electrolytic solution,
wherein
the positive electrode includes a positive electrode active material layer,
the negative electrode includes a negative electrode active material layer,
a length of the negative electrode active material layer in a winding axis direction of the wound electrode body is 200 mm or more,
an infiltration speed of the nonaqueous electrolytic solution in the negative electrode active material layer is 0.02 μL/s or more and 0.05 μL/s or less,
a distance between an end portion of the positive electrode active material layer and an end portion of the negative electrode active material layer is more than 0 mm and 5 mm or less on at least one side in the winding axis direction, and
in a fully charged state,
a ratio of a volume of the nonaqueous electrolytic solution to a total void volume of the positive electrode active layer and the negative electrode active layer in the wound electrode body is 130% or less.

2. The nonaqueous electrolyte secondary battery according to claim 1,
wherein
in the fully charged state,
a ratio of the volume of the nonaqueous electrolytic solution to a volume of a space in the battery case is 65% or more and 80% or less.

3. The nonaqueous electrolyte secondary battery according to claim 1,
wherein
in the fully charged state,
when it is assumed that a height of the wound electrode body is 100%, a liquid level height of the nonaqueous electrolytic solution is 10% or less.

4. The nonaqueous electrolyte secondary battery according to claim 1,
wherein
in a state where a charging depth (SOC) is 20%,
when it is assumed that a height of the wound electrode body is 100%, a liquid level height of the nonaqueous electrolytic solution is 7% or less.
